(19) United States
(12) Patent Application Publication
(10) Pub. No.: US 2016/0244107 A1
(43) Pub. Date: Aug. 25, 2016

(54) AERODYNAMIC CONTROL DEVICE OF A MOBILE BODY

(71) Applicant: TOYOTA JIDOSHA KABUSHIKI KAISHA, Toyota-shi (JP)

(72) Inventor: Masatsugu ISHIBA, Gotenba-shi (JP)

(73) Assignee: TOYOTA JIDOSHA KABUSHIKI KAISHA, Toyota-shi (JP)

(21) Appl. No.: 15/041,796

(22) Filed: Feb. 11, 2016

(30) Foreign Application Priority Data
Feb. 19, 2015 (JP) 2015-31168

(51) Int. Cl. B62D 35/00; B62D 35/02

(52) U.S. Cl. CPC B62D 35/008; B62D 35/02

(57) ABSTRACT

There is provided an aerodynamic control device of a vehicle or other mobile body for stabilizing its behavior against a side wind disturbance during its running. The inventive device comprises a displaceable shielding member extending downwardly from a lower end edge between a front wheel and a rear wheel on each side of a body of a mobile body to cover a space below the lower end edge and prevent an air flow from entering into the space under the body and a controller which controls an shielding area of the shielding member covering the space below the lower end edges by moving the shielding member based on the direction of an air flow which the mobile body receives.

### TECHNICAL FIELD

The present invention relates to an aerodynamic control device of a vehicle, such as an automobile, an aircraft, a hovercraft, a linear motor car, a vessel or other mobile body, and more specifically to a device for changing an aerodynamic force which a vehicle or other mobile body receives during its running.

### BACKGROUND ART

During the running of a vehicle, such as an automobile, or other mobile body, the force (an aerodynamic force) which its body receives from an air flow flowing through its circumference greatly affects the running stability, fuel consumption, etc. of the vehicle or other mobile body, and such an aerodynamic force acting on a vehicle body or a fuselage varies depending upon running conditions (a moving speed, a turning behavior, etc.) of the vehicle or other mobile body or conditions (the direction, magnitude, etc.) of a wind or an air flow. Thus, so far, there have been various structures controlling an aerodynamic force acting on a body of a vehicle or other mobile body during its running so as to trying to stabilize the running behavior or motion of the body by changing an aerodynamic characteristic of the body in accordance with the running conditions and/or air flow conditions of the vehicle or other mobile body. For instance, in patent document 1, there has been propose a structure under a carrier rear portion of a large truck, in which, there is provided a side skirt of which width has made narrower toward the rear end in the direction of increasing the ground height, and the side skirt is equipped with a side straightening assist portion projecting below when a vehicle speed becomes beyond a set value, thereby reducing aerodynamic drag during the straight running of the vehicle. Further, in patent document 2, there has been proposed a structure for reducing an aerodynamic drag of a vehicle by taking in a travelling wind from the front of the vehicle and discharging the air flow to inclined portions of the rear undersurface, thereby suppressing the generation of vortices in separated regions of the vehicle rear end. Furthermore, in patent document 3, there has been proposed a structure for attaining a running stability of a vehicle, in which the right and left corner portions of a bumper cover in the forward end of a vehicle are independently projectable based upon a vehicle speed, a steering angle, a yaw rate, etc., respectively, thereby reducing aerodynamic drag in the right and left corner portions at the forward end of the vehicle according to its turning condition.

### PRIOR TECHNICAL DOCUMENTS

### Patent documents

Patent document 1: JP2013-52762

Patent document 2: JP2005-170304

Patent document 3: JP2008-62847

### SUMMARY OF INVENTION

### Technical Problem

By the way, when a running vehicle receives a side wind, the stabilization of the behavior of the vehicle is typically conducted by controlling road surface reaction forces of tires. However, in a case of a light-weighted and drag-reduced compact vehicle, the effect of the behavior stabilization through the control of road surface reaction forces on tires becomes smaller as compared with usual vehicles. In a compact vehicle, the tire width is narrow and the ground contact load is also small, and thus, the lateral force which can be generated on a tire is comparatively small, and accordingly, there is a possibility that a sufficient tire lateral force could not be generated for suppressing influences of a side wind disturbance onto a vehicle. Then, in a case that the effect of the control of the road surface reaction force of a tire is comparatively low, such as in a case of a light-weighted vehicle, a mobile body moving in the air, etc., it is considered to control an aerodynamic characteristic of a vehicle body or a fuselage for the behavior stabilization against a side wind disturbance in a vehicle or a mobile body etc.

With respect to the aerodynamic characteristic of a vehicle body or a fuselage, briefly, first, the aerodynamic drag of a body almost corresponds to the surface integral of the pressure field exerted thereon in the direction opposite to the moving direction of a vehicle or other mobile body, and therefore, in one way of reduction of the drag in fluid of a vehicle or other mobile body during running straight, generally, corner portions on a vehicle body or a fuselage are formed into a curved surface shape with a large curvature radius. However, as explained in detail later in the column of Embodiments, if a side wind acts on a mobile body of such a shape in the presence of a significant yaw angle to its moving direction, a large yaw moment in a direction of turning round the mobile body to the leeward side and/or a large lateral force will be generated (For example, when applying a wing-shaped profile, known as a low drag shape, on which corner portions are formed into curved surface shape with a large curvature radius, to a vehicle or other mobile body equipped with a living space in its center section, the aerodynamic center point (the action point of an aerodynamic force) becomes situated near the position of the distance of about one fourth of the whole length of the body, measured from the forward end of the body, so that a turning yaw moment to the leeward side will be generated according to the lateral force by the side wind.), and further, a lift force variation occurs so that the stability in the moving direction of a vehicle or other mobile body will be decreased. Briefly speaking, this phenomenon is caused by that the shape of a vehicle body or a fuselage is designed such that its aerodynamic drag is reduced when a vehicle or other mobile body is running straight while it is hardly taken into account the route of an air flow, generated in the presence of a side wind, depending upon that shape. Therefore, for an aerodynamic characteristic control of a vehicle body or a fuselage for the behavior stabilization against a side wind disturbance, it can be considered to change the shape of a vehicle body or a fuselage and thereby change the route of an air flow in the present of the side wind so as to reduce a lateral force and a turning yaw moment to the leeward side while the aerodynamic drag is suppressed low in the absence of a side wind (during running straight). This knowledge is used in the present invention.

Thus, one of object of the present invention is to provide an aerodynamic control device of a vehicle or other mobile body, achieving the behavior stabilization against a side wind disturbance for the vehicle or other mobile body during running in the presence of a side wind.

Further, another object of the present invention is to provide such an aerodynamic control device of a vehicle or other mobile body, which controls the shape of a vehicle body or a fuselage such that the aerodynamic drag of the body is reduced during the running straight of the vehicle or other mobile body in the absence of a side wind while a lateral force and a turning yaw moment to the leeward side are reduced in the presence of a side wind.

### Solution to Problem

According to the present invention, the above-mentioned object is achieved by an aerodynamic control device of a mobile body, comprising: a displaceable shielding member extending downwardly from a lower end edge between a front wheel and a rear wheel on each of opposite sides of a body of a mobile body to cover a space below the lower end edge of the body and prevent an air flow from entering into the space under the body; and a controller controls a shielding area of the shielding member covering the space below the lower end edge of the body by moving a position of the shielding member, the controller controlling the shielding area of the shielding member based on a direction of an air flow which the mobile body receives. In this structure, the “mobile body” is typically a vehicle, such as an automobile, but, it may be a mobile body which can move while floating in the air, such as a flying vehicle, an aircraft, etc. The “body” is a vehicle body when the “mobile body” is a vehicle. In a case of a vehicle, such as an automobile, the “lower end edge between a front wheel and a rear wheel” corresponds to a rocker panel. The “shielding member” may be, typically, a plate member extendable downwardly from the rocker panel or lower end edge on the corresponding body side, and in a condition that the shielding member has extended by a significant length from the rocker panel or lower end edge, the entering of an air flow around the body from the body side to the underfloor space of the body is prevented. On the other hand, when the shielding member does not extend below the rocker panel or lower end edge, it is allowed for an air flow around the body to enter from a body side through below the rocker panel or lower end edge to the underfloor space of the body.

In the above-mentioned inventive device, briefly, as described above, the shielding area of the shielding member, namely, the extending range of the shielding member covering the space below the rocker panel or lower end edge of the body, is controlled based on the direction of an air flow which the mobile body receives. Thus, depending upon the direction of an air flow which the mobile body receives, it becomes possible to control the flow of air between the body side and the underfloor of the body of the mobile body so that the aerodynamic characteristic of the mobile body becomes more suitable.

In the above-mentioned inventive structure, preferably, the controller is designed to control the shielding area such that the shielding area of the shielding member when a yaw angle of the air flow which the mobile body receives exceeds beyond a predetermined angle becomes smaller, as compared with when the yaw angle of the air flow which the mobile body receives does not exceeds beyond the predetermined angle. As noted, generally, when a mobile body does not receive a substantial side wind, it is preferable to make the air flow pass along the outer surface of the body of the mobile body in its longitudinal direction while preventing the air flow from entering from the body side to the under floor of the body. On the other hand, when a mobile body receives a substantial side wind, in a case of the structure in which the air flow is prevented from entering from the body side of the mobile body, the air flow collides against the body side on the windward side, and thereby a yaw moment and a lateral force turning round the front portion of the body to the leeward side acts on the body, and also, a lift (a lifting action of the body) will increase because it is difficult for the air flow to flow through the underfloor of the body. In this respect, in the above-mentioned inventive device, as the shielding area of the shielding member becomes larger, the flow amount of the air flow entering into the underfloor of the body from the body side of the mobile body is reduced. Therefore, generally speaking, it is preferable to control the shielding area of the shielding member such that the entering of an air flow from the body side is prevented by expanding the shielding area of the shielding member in the absence of a side wind (i.e., in the situation where only a travelling wind exists substantially in the longitudinal direction of the body). On the other hand, in the presence of a side wind, it is preferable that the shielding area of the shielding member is made smaller, making it easier for an air flow to enter from the body side. And, a yaw angle of an air flow which the mobile body receives increases together with the increase of the flow amount of a side wind, and therefore, through controlling the shielding area to be smaller when the yaw angle exceeds beyond a predetermined angle as compared with when the yaw angle does not exceeds beyond the predetermined angle as noted above, it can be achieved to provide an aerodynamic characteristic in the body such that its aerodynamic drag is reduced in the absence of a side wind while a turning yaw moment or a lateral force to the leeward side and a lift are reduced in the presence of a side wind.

In this regard, in the controlling of the shielding area of the shielding member, concretely, the controller may be designed to control an extending distance or a projection distance of the shielding member from the lower end edge between the front wheel and rear wheel on each of the opposite sides of the body of the mobile body. In that case, the shielding area of the shielding member may be controlled to be expanded to its maximum when the yaw angle of the air flow which the mobile body receives does not exceed beyond the predetermined angle, and to be contracted to its minimum when the yaw angle of the air flow which the mobile body receives exceeds beyond the predetermined angle. The extending distance, projection distance or shielding area of the shielding member from the lower end edge between the front wheel and rear wheel on each of the opposite sides of the body when the yaw angle of the air flow which the mobile body receives does not exceed beyond the predetermined angle may be determined theoretically or experimentally so as to fully reduce the aerodynamic drag of the body in the absence of a side wind without causing any hindrance in the moving of the mobile body, while taking into account the shape of the whole body. Further, the extending distance, projection distance or shielding area of the shielding member from the lower end edge between the front wheel and rear wheel on each of the opposite sides of the body when the yaw angle of the air flow which the mobile body receives exceeds beyond the predetermined angle may be determined theoretically or experimentally so as to allow a sufficient amount of the air flow through the underfloor of the body in the presence of a side wind, while taking into account the shape of the whole body.

In one embodiment of the above-mentioned inventive device, the device may be designed such that the shielding area of the shielding member substantially over the almost whole length of the lower end edge between the front wheel and rear wheel of the body is changeable based on the direction of the air flow which the mobile body receives. Namely, the air flow in the space below the lower end edge over the whole length between the front wheel and rear wheel on the body side is controlled based on the direction of the air flow which the mobile body receives. In this case, concretely, the shielding member may be designed to be movable relative to the corresponding lower end edge of the body in its vertical direction, and thus, the control of the shielding area of the shielding member will be achieved by controlling the position of the shielding member in the vertical direction. Further, in a case of controlling the air flow in the space below the lower end edge over the whole length between the front wheel and rear wheel on the body side, the shielding member may be designed to be movable between a full open position in which the space below the lower end edge between the front wheel and rear wheel on each of the opposite sides of the body is fully opened and a shielding position in which the space below the lower end edge is shielded by a predetermined range. In a case of the structure in which the shielding area is controlled such that the shielding area of the shielding member when the yaw angle of the air flow which the mobile body receives exceeds beyond a predetermined angle becomes smaller as compared with when the yaw angle of the air flow which the mobile body receives does not exceed beyond the predetermined angle, the entering of an air flow into the space below the lower end edge from the body side over the whole length between the front wheel and rear wheel on the body side may be substantially prevented when the yaw angle of the air flow which the mobile body receives does not exceed beyond the predetermined angle, and the entering of the air flow into the space below the lower end edge from the body side over the whole length between the front wheel and rear wheel on the body side may be allowed when the yaw angle of the air flow which the mobile body receives exceeds beyond the predetermined angle. In that case, when the yaw angle of the air flow which the mobile body receives exceeds beyond the predetermined angle, an air flow will flow into the body underfloor over the whole length between the front wheel and rear wheel on the body side, so that it becomes possible to enlarge the reduction effects of the lateral force and the turning yaw moment to the leeward and the lift.

In another embodiment of the above-mentioned inventive device, the device may be designed such that the shielding area of the shielding member covering a front portion of a predetermined length of the lower end edge between the front wheel and rear wheel is changeable based on the direction of the air flow which the mobile body receives. Namely, the air flow in the space below the front portion of the lower end edge between the front wheel and rear wheel on the body side is controlled based on the direction of the air flow which the mobile body receives. In this case, concretely, the front portion of the shielding member may be designed to be movable relative to a rear portion of the shielding member in the longitudinal direction of the body, and thus, the control of the shielding area of the shielding member can be achieved, for example, by making the front portion of the shielding member overlap on the rear portion of the shielding member in the lateral (width) direction of the body. Or alternatively, only for the front portion of the shielding member, its position in the vertical direction may be controlled. Further, the shielding member may be designed to be movable between a front portion full open position, in which the front portion in the longitudinal direction of the space below the lower end edge between the front wheel and rear wheel on each of the opposite sides of the body is fully opened, and a shielding position, in which the space below the lower end edge is shielded by a predetermined range. In this manner, in a case of the structure in which the shielding area is controlled such that the shielding area of the shielding member when the yaw angle of the air flow which the mobile body receives exceeds beyond a predetermined angle becomes smaller as compared with when the yaw angle of the air flow which the mobile body receives does not exceed beyond the predetermined angle, the entering of the air flow into the space below the lower end edges from the body side over the whole length between the front wheel and rear wheel on the body side may be substantially prevented when the yaw angle of the air flow which the mobile body receives does not exceed beyond the predetermined angle, and the entering of the air flow into the space below the lower end edge from the body side only in the front portion between the front wheel and rear wheel on the each of the opposite sides may be allowed when the yaw angle of the air flow which the mobile body receives exceeds beyond the predetermined angle. In that case, when the yaw angle of the air flow which the mobile body receives exceeds beyond the predetermined angle, the air flow flows into the body underfloor without colliding with the shielding member only in the front portion between the front wheel and rear wheel on the body side, and thereby, the reduction effects of the lateral force and turning yaw moment to the leeward side and the lift are obtained, and also, in the rear portion between the front wheel and rear wheel on the body side, an air flow (side wind) collides with the shielding member from the body outside, and therefore, this aerodynamic force produces an anti-yaw moment in the direction opposite to the direction in which the side wind tries to turn round the front of the body from the windward side to the leeward side. In this regard, although the front portion between the front wheel and rear wheel on the body side may be generally a portion in front of the centroid of the mobile body, the boundary between the front portion and the rear portion needs not exactly coincide with the centroid position of the mobile body, and may be forward or rearward of the centroid of the mobile body, depending upon the designing, etc. of the body.

### Effect of Invention

Thus, in the above-mentioned present invention, it becomes possible to change an aerodynamic characteristic of a body of a mobile body in accordance with the direction of an air flow which the mobile body receives by controlling the entering of an air flow from a body side to a space below a rocker panel or a lower end edge of the body based on the direction of the air flow which the mobile body receives. Especially, with reference to the aerodynamic characteristics realized in the presence and absence of a side wind in a case of the structure in which the shielding area of shielding member is controlled to be smaller when the yaw angle of an air flow which the mobile body receives exceeds beyond a predetermined angle as compared with when the yaw angle of the air flow which the mobile body receives does not exceed beyond the predetermined angle, the entering of the air flow from the side part of a body is prevented so that a condition of relatively low aerodynamic drag can be established in the body in the absence of a side wind, while, in the presence of a side wind, an air flow passes through the underfloor from the body side so that the pressure on the body side will be reduced, and thereby a turning yaw moment and a lateral force to the leeward side are reduced, and also because the air flow is formed in the underfloor, an action reducing the lift of the body (downforce) will be produced. Therefore, in accordance with the structure of the present invention, by changing an aerodynamic characteristic of a body of a mobile body between in the presence and absence of a side wind, the behavior stabilization will be attained in both the conditions. In this regard, it should be understood that the present invention, when applied to a mobile body moving in the air, provides its operations and effects, and such a case belongs to the scope of the present invention, also.

Other purposes and advantages of the present inventions will become clear by explanations of the following preferable embodiments of the present invention.

### BRIEF DESCRIPTIONS OF DRAWINGS

FIG. 1A is a schematic drawing of a vehicle to which an aerodynamic control device in accordance with the present invention is applied, showing an example in which a shielding member is movable up and down over the whole length of the lower end edges between the front wheel and rear wheel on each of the opposite body sides of the vehicle. FIGS. 1B and 1C are sectional views (along the body side and along the body width) of the shielding member of the aerodynamic control device of FIG. 1A, each showing a condition that the shielding member is stored above the lower end edge on the vehicle body side (full open position), and a condition that the shielding member projects and extends below from the lower end edge on the vehicle body side (shielding position), respectively. FIG. 1D is a schematic drawing of a type of controlling the shielding area by swinging a shielding member.

FIG. 2A is a schematic drawing of a vehicle to which an aerodynamic control device in accordance with the present invention is applied, showing an example in which a shielding member extending over the whole length of a vehicle body side lower end edge between the front wheel and rear wheel on each of the opposite sides of the vehicle comprises a front portion and a rear portion, and the front portion can be stored in the rear portion. FIGS. 2B and 2C are sectional views (along the body side) of the shielding member of the aerodynamic control device of FIG. 2A, respectively, each showing a condition in which the front portion of the shielding member projects in front of the rear portion so that the shielding member extends downwardly from the vehicle body side lower end edge over its whole length between the front wheel and rear wheel (shielding position) and a condition in which the front portion of the shielding member is stored in the rear portion so that the portion below the front portion of the vehicle body side lower end edge is opened (front portion full open position).

FIGS. 3A and 3B each schematically show a side view of a vehicle to which an aerodynamic control device in accordance with the present invention is applied and its cross-sectional plan view in a plane X-X in FIG. 3A, showing a distribution of pressure and air flows which the vehicle body receives in a condition that shielding members extend downward of the vehicle body side lower end edges between the front wheel and rear wheel over its whole length on the opposite sides of the vehicle body. FIGS. 3C and 3D each schematically show a side view of a vehicle to which an aerodynamic control device in accordance with the present invention is applied and its cross-sectional plan view in a plane X-X in FIG. 3C, showing a distribution of pressure and air flows which the vehicle body receives in a condition that shielding members are stored upward of the vehicle body side lower end edges between the front wheel and rear wheel over its whole length on the opposite sides of the vehicle body.

FIGS. 4A and 4B each schematically show a side view of a vehicle to which an aerodynamic control device in accordance with the present invention is applied and its cross-sectional plan view in a plane X-X in FIG. 4A, showing a distribution of pressure and air flows which the vehicle body receives in a condition that only the front portions of the shielding members are opened in the space between the front wheel and a rear wheel below the vehicle body side lower end edges on the opposite sides of the vehicle body.

FIG. 5 explains about relative changes of aerodynamic drag coefficient ΔCD and yaw moment coefficient ΔCY in a vehicle to which an aerodynamic control device in accordance with the present invention is applied in a condition that shielding members extend below the vehicle body side lower end edges between the front wheel and rear wheel over its whole length (fully closed, the condition of FIGS. 3A and 3B); in a condition that shielding members are stored above the vehicle body side lower end edges between the front wheel and rear wheel over its whole length (fully opened, the condition of FIGS. 3C and 3D) and in a condition that only the front portion of the shielding member is opened in the space between the front wheel and a rear wheel below the vehicle body side lower end edges (front opened, condition of FIGS. 4A and 4B).

FIGS. 6A and 6B each schematically show a side view of a mobile body hovering in the air to which an aerodynamic control device in accordance with the present invention is applied and its cross-sectional plan view in a plane X-Xin FIG. 6A, showing a distribution of pressure and air flows which the body receives in a condition that shielding members extend downward of the body side lower end edges between the front wheel and rear wheel over its whole length. FIGS. 6C and D each schematically show a side view of a mobile body hovering in the air to which an aerodynamic control device in accordance with the present invention is applied and its cross-sectional plan view in a plane X-X in FIG. 6C, showing a distribution of pressure and air flows which the body receives in a condition that shielding members are stored upward of the body side lower end edges between the front wheel and rear wheel over its whole length.

### EXPLANATIONS OF REFERENCE NUMERALS

10—Vehicle or other mobile bodies
11—Body side lower edge
10F—Vehicle body floor
12F—Front wheel
12R—Rear wheel
14, 24—Aerodynamic control device
15, 25—Housing
16, 26—Shielding member
17, 27—Holding member
18, 28—Motor
19, 29—Ball screw
30—Front end movable side skirt
40—Rear end movable side skirt

### DESCRIPTION OF EMBODIMENTS

In the followings, preferable embodiments of the present invention are described in detail.

### Structure of Aerodynamic Control Device

In an aerodynamic control device according to the present invention, as described in the column of “Summary of Invention”, briefly, an aerodynamic characteristic of a vehicle body or a fuselage (hereafter, referred to as a “body”) of a running vehicle or other mobile body is controlled by changing the position of a shielding member capable of extending downward from a lower end edge on each side of the body to selectively restrict or permit the entering of an air flow from a body side to the space under the body based on the direction of an air flow which a running vehicle or other mobile body receives.

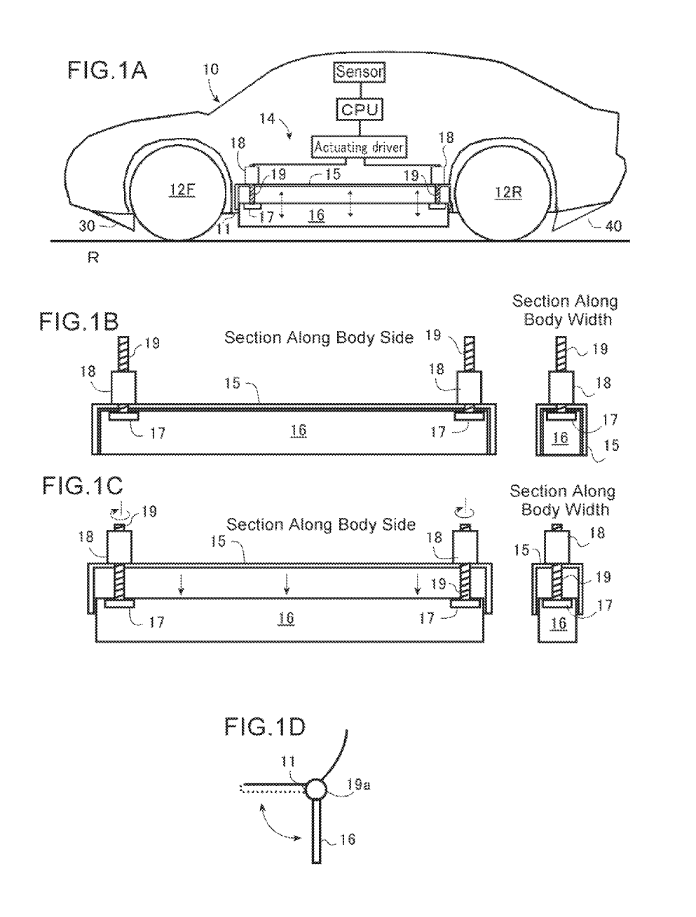

With reference to FIG. 1A, in one embodiment of an aerodynamic control device according to the present invention, a vehicle 10 running on a road surface R is provided with an aerodynamic control device 14 which covers the region below a lower end edges 11 between front wheels 12F and rear wheels 12R on each of the opposite sides of the body to selectively restrict or prevent the entering of an air flow into the underfloor of the body of the vehicle 10. The aerodynamic control device 14 comprises a shielding member 16 extending substantially over the whole length of the lower end edge 11 between the front wheel 12F and rear wheel 12R and being displaceable below the lower end edge 11, and a housing 15 provided above the lower end edges 11 and being capable of storing the shielding member 16 therein on each side of the body. The shielding member 16 is equipped with a holding member 17 to which a ball screw 19 is fixed near each of the opposite ends (the front end and rear end in the longitudinal direction of the vehicle), and further, as explained later, each ball screw 19 is connected with a rotary motor 18 driven by an actuating driver according to a control demand of a CPU. The CPU determines the position of the shielding member 16 in the vertical direction according to a detected value of a wind direction from a wind direction sensor which detects in an arbitrary way the direction of a wind which the vehicle receives, drives the actuating driver according to the determination and displaces the shielding member 16 in the vertical direction.

More in detail, as schematically drawn on FIGS. 1B and 1C, the shielding member 16 is displaced between a position in which the shielding member 16 is stored in the housing 15 above the lower end edge 11 of the vehicle body and renders a space below the lower end edge 11 to be “open” (full open position-FIG. 1B) and a position in which the shielding member 16 projects from and extends downward of the lower end edge 11 and shields the space below the lower end edge 11 (shielding position-FIG. 1C). The displacement of the shielding member 16 may be achieved, for example, by a structure in which the shielding member 16 is displaced up and down together with the moving up and down of the ball screw 19 and the holding member 17 by the rotary motor 18 rotating relatively to the ball screw 19. In this regard, as shown in FIG. 1D, the shielding member 16 may be displaced between the shielding position and the full open position by being swung around a hinge axis 19a.

For a wind direction sensor, an arbitrary sensor device which directly detects a wind direction may be used. Further, the wind direction sensor may be a device, etc. (not shown) which judges whether or not a yaw rate and a roll rate, detected by a gyro sensor often equipped on a vehicle, are in the opposite phases to one another (When the yaw rate and roll rate are in the opposite phases, it is judged the a side wind in the direction of the roll rate exists.).

As understood more in detail in explanations described later, with respect to air flows around the body and the distribution of pressures which the body receives in a running vehicle, preferably, the area covered by the shielding member 16 which shields the space below the lower end edge 11 in the shielding position (“shielded area”), is set to substantially prevent the air flow from entering from the lower end edge 11 on the body side into the underfloor of the body. Also, preferably, the area uncovered by the shielding member 16 which opens the space below the lower end edge 11 in the full open position (“opened area”) is set to allow a significant amount of an air flow entering from the lower end edge 11 on the body side into the underfloor of the body. The shielded area in the shielding position and the opened area in the full open position of the shielding member 16 may be arbitrarily set by one skilled in the art while taking into account the design of the whole vehicle shape.

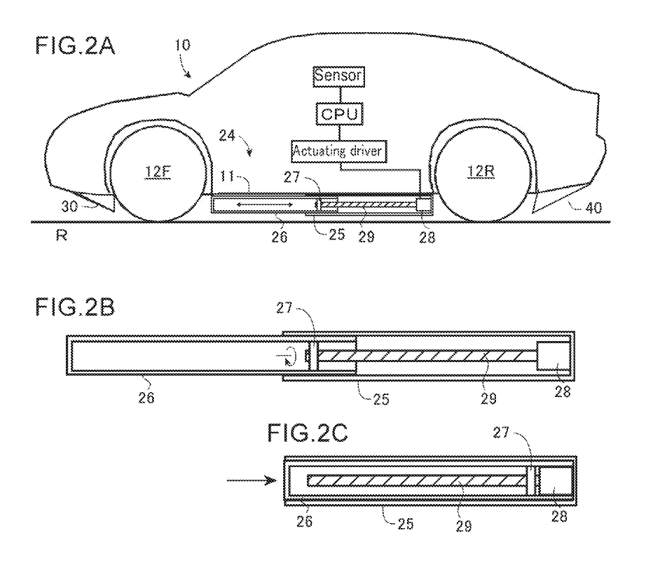

In another embodiment of an aerodynamic control device according to the present invention schematically drawn in FIG. 2A, similarly to the case of

FIG. 1A, an aerodynamic control device 24 is provided at a lower end edge 11 between a front wheel 12F and a rear wheel 12R on each of the opposite sides of a vehicle 10 running on a road surface R, and the device 24 also covers the region downward of the lower end edge 11 to selectively restrict or prevent the entering of an air flow into the underfloor of the body of the vehicle 10. However, the aerodynamic control device 24 comprises a shielding member 26, extending along the front portion of the lower end edge 11 between the front wheel 12F and rear wheel 12R, and a housing 25, extending along the rear portion of the lower end edge 11. At the rear end of the housing 25, there is mounted a motor 28, to which a ball screw 29, extending along with the lower end edge 11, is connected, and further, the shielding member 26 is secured with a holding member 27 to the ball screw 29. Thus, when the motor 28 rotates, the ball screw 29 also rotates, and then, according to this rotation, the position of the holding member 27 is moved so that the shielding member 26 will be displaced in the longitudinal direction of the body. To the motor 28, similarly to the case of FIG. 1A, a control demand is given from a CPU in accordance with a detected value of a wind direction from a wind direction sensor which detects in an arbitrary way the direction of the wind which a vehicle receives, and thereby, the position of the shielding member 26 in the longitudinal direction is controlled.

In the case of the embodiment of FIG. 2A, as understood from FIGS. 2B, 2C, the shielding member 26 is displaced between a position of shielding the space below the lower end edge 11 over its whole length (shielding position-FIG. 2B) and a position of opening only the front portion of the space below the lower end edge 11 by storing the shielding member 26 into the rear housing 25 (Front portion full open position-FIG. 2C). Accordingly, in the case of FIG. 2A, the housing 25 also functions as a shielding member which covers a part of the space below the lower end edge 11. In this respect, similarly in the case of FIG. 1A, preferably, the area covered by the shielding member 26 which shields the space below the lower end edge 11 in the shielding position (“shielded area”) is set to substantially prevent an air flow from entering from the lower end edge 11 on the body side into the underfloor of the body. On the other hand, it is preferable that an area uncovered by the shielding member 26 which opens the space below the lower end edge 11 in the front portion full open position (“front portion opened area”) is set to allow a significant amount of an air flow entering from only the front portion of the lower end edge 11 on the body side into the underfloor of the body. The shielded area in the shielding position and the front portion opened area in the full open position of the shielding member 26 may be arbitrarily set by one skilled in the art while taking into account the design of the whole vehicle shape. The position of the rear end of the front portion of the space below the lower end edge 11 on the body side, i.e., the boundary between the front portion and rear portion in the longitudinal direction, may almost coincide with the centroid position of the vehicle, but it may be forward or rearward of the centroid position, depending upon the design of the body, etc. Furthermore, similarly to the case of FIG. 1A or FIG. 1D, the shielding member 26 may be designed to be displaceable in the vertical direction, and thus, in the front portion full open position, the shielding member 26 may be stored above the lower end edge 11. In that case, the housing 25 may be substituted to a fixed plate member, etc. which serves simply to shield the rear portion of the space below the lower end edge 11.

Further, in addition to the shielding member between the front wheel 12F and rear wheel 12R on each body side, there may be provided a front end movable side skirt 30 and a rear end movable side skirt 40 in front of the front wheel 12F and behind the rear wheel 12R, respectively. These movable side skirts may be displaced together with the displacement of the shielding member 16 or 26, where these skirts may project below when the shielding member 16 or 26 is in the shielding position while these may be stored above the lower end of the body when the shielding member 16 or 26 is in the full open position or the front portion full open position (In the structure of FIG. 2A, the rear end movable side skirt 40 may be fixed to the position projecting downward irrespective of the position of the shielding member 26.).

The above-mentioned structures of the aerodynamic control devices 14 and 24 can be applied to not only vehicles running on the land, such as an automobile, but also mobile bodies floating in the air, such as flying vehicles, aircraft, etc., and it should be understood that such cases belong to the scope of the present invention.

### Operation of Aerodynamic Control Device

As already noted, in the operations of both of the control devices 14 and 24, when a yaw angle of an air flow which a body receives detected by the sensor during the running of a vehicle does not exceed beyond a predetermined angle (angle threshold value), the shielding member 16 or 26 is set to be in the shielding position. The predetermined angle is an angle at which it can be substantially considered that no significant side wind exists, and may be set experimentally or theoretically. In this condition, the air flow entering from a body side through the lower end edge 11 into the space under the body is restricted, and therefore, in the aerodynamic characteristic of the body, as described later, the aerodynamic drag of the body is reduced when the travelling wind flows only in the longitudinal direction, and also, preferably, a downforce is generated by the presence of a significant air flow which flows rearward from the front of a vehicle through the space under the body.

On the other hand, when the yaw angle of the air flow which the body receives exceeds beyond the predetermined angle, namely, when it is judged that a significant side wind exists substantially, the CPU gives a control demand to the actuating driver, and thereby, the motor drives to displace the shielding member 16 or 26 to the full open position or the front portion full open position. In this condition, an air flow is allowed to enter from a body side through the lower end edge 11 into the space under the body, and therefore, in the aerodynamic characteristic of the body, as described later, the component of a side wind in an air flow is released into the space under the body so that the turning yaw moment and lateral force to the leeward side are reduced, and also, preferably, a downforce is generated by the presence of a significant air flow which flows from the windward side to the leeward side through the space under the body.

In this connection, it should be understood that, in the above-mentioned structure, it is not required to detect the value of the yaw angle of an air flow explicitly. In a case of a structure of detecting an arbitrary index indicating whether or not a significant amount of a side wind component exists in an air flow, it is possible to judge that a yaw angle exceeds beyond the predetermined angle by means of the index showing the presence of a significant amount of a side wind component, and therefore, the control of displacement of the shielding member may be performed in accordance with such an index detecting the presence of a side wind component, and such cases belong to the scope of the present invention.

### Operation and Effect of the Inventive Aerodynamic Control

In the following, concrete operational effects of an air flow to a body in accordance with the operation of the above-mentioned aerodynamic control devices 14 and 24 will be explained.

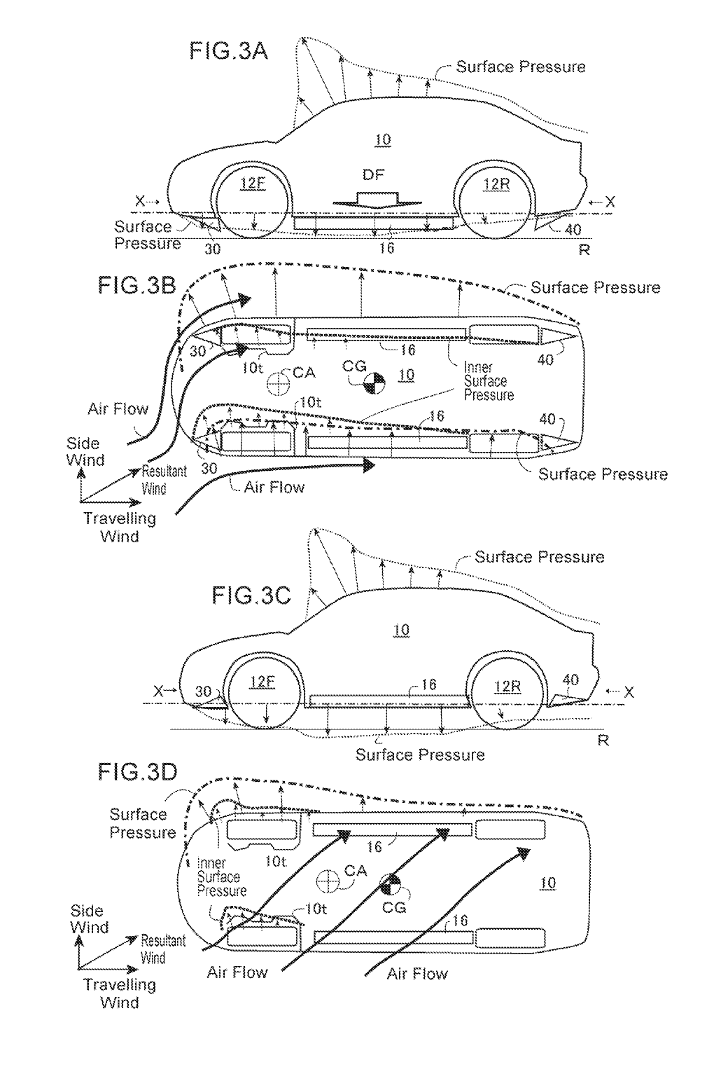

First, referring to FIG. 3A, when the shielding member 16 or 26 is in the shielding position, as already noted, since the shielding member 16 or 26 blocks the route of an air flow entering from a body side through the lower end edge 11 into the space under the body, an air flow will flow along the top and bottom surfaces and right and left sides of the body in its longitudinal direction of the body, and thereby, the turbulence in the air flow is small and its aerodynamic drag becomes low. In that case, in the body, a pressure distribution is formed as shown in the drawing (where arrows indicate force directions.), where an action (lift) which brings the body upward occurs on the top surface while a downforce DF which pulls the body downward occurs on the bottom surface (the vehicle body underfloor).

However, when a side wind occurs as illustrated in FIG. 3B, the vehicle 10 receives the resultant wind of the side wind and travelling wind. In that case, if the route from the lower end edge 11 of the body side into the space under the body is blocked, an air flow collides with the body side in the windward side while an air flow flows along the body side in the leeward side as shown in the drawing. Then, on both the body surfaces in the windward side and leeward side, a surface pressure distribution is produced as illustrated, and also, an inner surface pressure distribution is produced as illustrated because of collision of the air flow entering from the circumference of the front wheel with an internal structure of the front wheel (arrows drawn in the surface pressure distribution and inner surface pressure distribution in the drawings indicate force directions.). And, owing to the surface pressure distribution and the inner surface pressure distribution occurring in this condition, in total, a lateral force which pushes the body into the leeward side and a turning yaw moment which turns round the front of the body to the leeward side are produced (In detail, the lateral force and turning yaw moment actually acting on the body are the force and the moment, obtained by integrating the surface pressure distribution and inner surface pressure distribution, respectively. In the presence of a side wind, the pressure of the front region of the vehicle is relatively high as illustrated in the pressure distribution, and also, the aerodynamic center C.A (the point of action of an aerodynamic force) is at a distance of about ¼ of the whole length of the vehicle from the vehicle front end, forward of the centroid CG of the vehicle, and accordingly, the turning yaw moment to the leeward side is generated.). Namely, in the condition that the route from the lower end edge 11 of the body side into the space under the body is blocked, when a side wind occurs, a lateral force and a turning yaw moment to the leeward side are generated on the body, decreasing its behavioral stability.

Thus, when a side wind occurs as in the above, the shielding member 16 or 26 is moved to the full open position or the front portion full open position as noted, and thereby the route from the lower end edge 11 of the body side into the space under the body is released for reducing the lateral force and turning yaw moment pushing the body to the leeward side.

Concretely, in the structure of FIG. 1A, the shielding member 16 is displaced to the full open position so that the space below the lower end edge 11 is made opened, and thereby, an air flow can flow into the space under the body as drawn in FIG. 3D. Then, the air flow which collides with a body side in the windward side and the air flow which flows along the body side in the leeward side are reduced, and thereby, pressures in the surface pressure distribution and inner surface pressure distribution are largely reduced as illustrated so that the lateral force which pushes the body onto the leeward side and the turning yaw moment which turns round the front of the body to the leeward side will be largely reduced (Since the aerodynamic-center C.A becomes relatively closer to the centroid CG, the yaw moment by a side wind is reduced. In this regard, the pressure distribution in the longitudinal direction of the vehicle is not largely changed as drawn in FIG. 3C.).

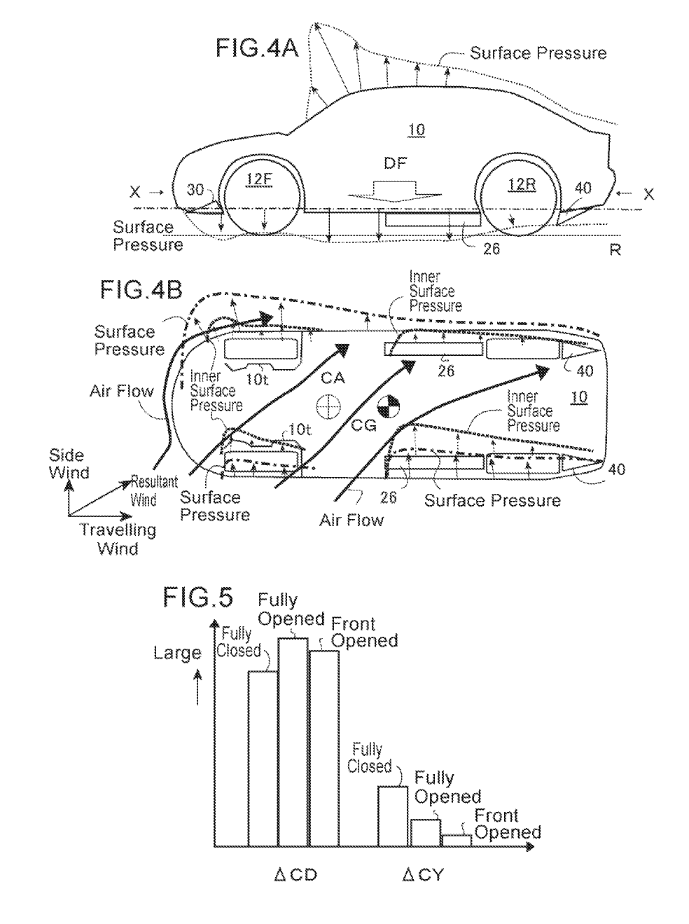

In the structure of FIG. 2A, the shielding member 26 is displaced to the front portion full open position so that only the front portion of the space below the lower end edge 11 is made opened, and thereby, a part of an air flow can flow into the space under the front portion of the body as drawn in FIG. 4B. Then, in the front portion of the body, the air flow which collides with the body side in the windward side and the air flow which flows along the body side in the leeward side are reduced, and thereby, pressures in the surface pressure distribution and inner surface pressure distribution are reduced as illustrated so that the lateral force which pushes the body onto the leeward side and the turning yaw moment which turns round the front of the body to the leeward side are reduced. Furthermore, in the case of the structure of FIG. 4B, since the housing 25 which functions as the shielding member 26 exists in the rear portion of the space below the lower end edge 11, the air flow collides with the housing 25, and thereby, near the rear wheels, a lateral force to the leeward side occurs as shown in the surface pressure distribution and inner surface pressure distribution. This lateral force acts on the portion rearward of the centroid CG of the vehicle, and thus it generates a yaw moment which turns the rear of the body to the leeward side, i.e., an anti-yaw moment in the direction of cancelling the turning yaw moment by a side wind.

FIG. 5 schematically shows differences in aerodynamic drag coefficient ΔCD and yaw moment coefficient ΔCY in the cases of FIG. 3B (fully closed), FIG. 3D, (fully opened) and FIG. 4B and (front opened) (the aerodynamic drag coefficient ΔCD and yaw moment coefficient ΔCY are the values obtained by rendering a longitudinal direction drag force and a turning yaw moment generated in a body by an air flow to be dimensionless, respectively.). Referring to the drawing, in the cases of FIG. 3D (fully opened) and FIG. 4B (front opened), the aerodynamic drag coefficient ΔCD increases because of the presence of the entering of an air flow from the lower end edge 11 of the body into the space under the body as compared with in the case FIG. 3B (fully closed) while the yaw moment coefficient ΔCY decreases owing to the reduction of collision of the air flow with the body side and the reduction of the air flow flowing horizontally along the circumference of the body. Further, in the case of FIG. 4B, as noted, since an anti-yaw moment in the direction of cancelling the turning yaw moment by a side wind is generated in the rear portion of a vehicle, the yaw moment coefficient ΔCY is further reduced as compared with in the case of FIG. 3D (fully opened).

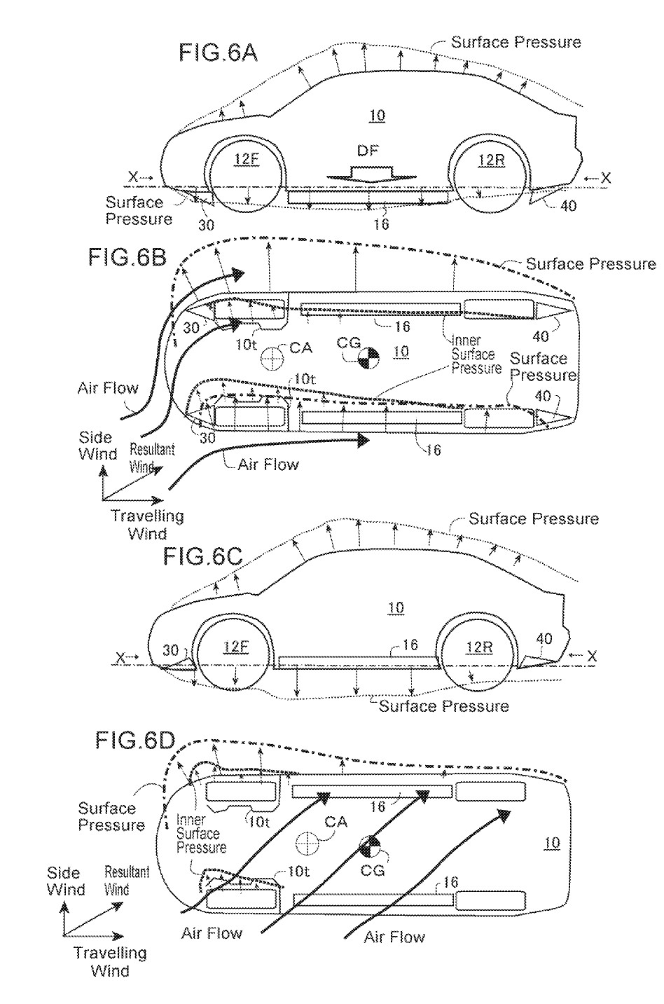

As noted, the above-mentioned inventive aerodynamic control device may be applied to a mobile body moving in the air, such as a flying vehicle, an aircraft, etc., and in such cases, operational effects similar to those as explained in FIGS. 3-5 are obtained. FIGS. 6A-6D schematically show a mobile body hovering in the air to which the structure of FIG. 1 (A) is applied, in which the distribution of pressure which a body of the mobile body receives and air flows around the body are drawn. Comparing with the cases of FIGS. 3A-3D, although the shape of the surface pressure distribution in the vertical direction of the mobile body is different from the former case because of the absence of road under the mobile body, the horizontal surface pressure distribution and inner surface pressure distribution of the mobile body are the almost same as in the former case. That is, because the space below the lower end edge 11 is opened so that the entering of an air flow into the space under the body is allowed, the lateral force pushing the body onto the leeward side and the turning yaw moment turning round the front of the body to the leeward side are largely reduced. In this regard, although not illustrated, when the structure of FIG. 2A is applied to a mobile body hovering in the air, there are obtained a surface pressure distribution and an inner surface pressure distribution similar to the case of FIG. 4B, and thus, the similar operational effects, i.e., the reduction of the lateral force pushing the body onto the leeward side and the turning yaw moment turning round the front of the body to the leeward side and the generation of an anti-yaw moment against the turning yaw moment by a side wind will be attained.

Thus, according to the above-mentioned structure, when a yaw angle of the air flow which a mobile body receives does not exceed beyond a predetermined value, the entering of the air flow to the space below the lower end edge 11 of a body of the mobile body is prevented, thereby reducing the lift of the body, and when the yaw angle exceeds beyond the predetermined value, the entering of the air flow to the space below the lower end edge 11 of a body of the mobile body is allowed, thereby reducing a lateral force pushing the body onto the leeward side and a turning yaw moment turning round the front of the body to the leeward side.

Although the above explanation has been described with respect to embodiments of the present invention, it will be apparent for those skilled in the art that various modifications and changes are possible, and that the present invention is not limited to the above-illustrated embodiments and may be applied to various devices and apparatus without deviating from the concepts of the present invention.

1. An aerodynamic control device of a mobile body, comprising:
a displaceable shielding member extending downwardly from a lower end edge between a front wheel and a rear wheel in each of opposite sides of a body of a mobile body to cover a space below the lower end edge of the body and prevent an air flow from entering into the space under the body; and;
a controller which control an shielding area of the shielding member covering the space below the lower end edge of the body by moving a position of the shielding member, the controller controlling the shielding area of the shielding member based on a direction of an air flow which the mobile body receives.

2. The device of claim 1, wherein, when a yaw angle of the air flow which the mobile body receives exceeds beyond a predetermined angle, the controller controls the shielding area of the shielding member to become smaller than when the yaw angle of the air flow which the mobile body receives does not exceed beyond the predetermined angle.

3. The device of claim 2, wherein the controller controls the shielding area of the shielding member such that the shielding area of the shielding member becomes its maximum when the yaw angle of the air flow which the mobile body receives does not exceed beyond the predetermined angle, and the shielding area of the shielding member becomes its minimum when the yaw angle of the air flow which the mobile body receives exceeds beyond the predetermined angle.

4. The device of claim 1, wherein the shielding area of the shielding member substantially over a whole length of the lower end edge between the front wheel and the rear wheel is changed based on the direction of the air flow which the mobile body receives.

5. The device of claim 1, wherein the shielding area of the shielding member over a front portion of a predetermined length in the lower end edge between the front wheel and the rear wheel is changed based on the direction of the air flow which the mobile body receives.

6. The device of claim 1, wherein the shielding member is movable in a vertical direction of the body relative to the lower end edge of the body.

7. The device of claim 1, wherein the shielding member is movable between a full open position in which the shielding member fully opens the space below the lower end edge between the front wheel and the rear wheel on each of the opposite sides of the body and a shielding position in which the shielding member shields a predetermined range of the space below the lower end edge between the front wheel and the rear wheel on each of the opposite sides of the body.

8. The device of claim 1, wherein a front portion of the shielding member is movable in the longitudinal direction of the body relative to a rear portion of the shielding member.

9. The device of claim 1, wherein the shielding member is movable between a front portion full open position in which the shielding member fully opens a front portion in the longitudinal direction of the mobile body of the space below the lower end edge between the front wheel and the rear wheel on each of the opposite sides of the body and a shielding position in which the shielding member shields a predetermined range of the space below the lower end edge between the front wheel and the rear wheel on each of the opposite sides of the body.
